(19) United States
(12) Patent Application Publication
(10) Pub. No.: US 2017/0171504 A1
(43) Pub. Date: Jun. 15, 2017

(54) METHOD AND APPARATUS FOR CONVERTING DEDICATED INTERFACE INTO HDMI INTERFACE

(71) Applicants: Le Holdings (Beijing) Co., Ltd., Beijing (CN); Le Shi Zhi Xin Electronic Technology (Tianjin) Limited, Tianjin (CN)

(72) Inventor: Qi CHANG, Tianjin (CN)

(21) Appl. No.: 15/249,524

(22) Filed: Aug. 29, 2016

Related U.S. Application Data
(63) Continuation of application No. PCT/CN2016/088620, filed on Jul. 5, 2016.

(30) Foreign Application Priority Data
Dec. 14, 2015 (CN) 201510943929.2

(51) Int. Cl. H04N 7/01; G06F 3/16; H04N 7/015

(52) U.S. Cl. CPC H04N 7/0125; H04N 7/015; G06F 3/162

(57) ABSTRACT

A method and an apparatus for converting a custom interface into an HDMI interface are disclosed, wherein the apparatus includes: a custom interface, configured to adaptively connect to a custom interface of a soundbar; an HDMI interface, configured to adaptively connect to an HDMI interface of a television; and a connecting cable, configured to separate an HDMI signal from a soundbar signal received by using the custom interface, and transmit the separated HDMI signal to the television by using the HDMI interface. In embodiments of the present disclosure, a custom interface is converted into an HDMI interface to implement video output of a soundbar having a custom interface and a television having an HDMI interface, thereby improving universality of a soundbar having a custom interface.

### CROSS-REFERENCE TO RELATED APPLICATIONS

This application is a continuation of PCT Application No. PCT/CN2016/088620 filed on Jul. 5, 2016, which claims priority to Chinese Patent Application No. 2015109439292, filed before State Intellectual Property Office of the P. R. China on Dec. 14, 2015 and entitled “METHOD AND APPARATUS FOR CONVERTING DEDICATED INTERFACE INTO HDMI INTERFACE”, the entire contents of which are incorporated herein by reference.

### TECHNICAL FIELD

The present disclosure relates to the technical field of video interfaces, and more particularly, to a method and an apparatus for converting a custom interface into a high definition multimedia interface (HDMI).

### BACKGROUND

Televisions, especially, smart televisions are becoming increasingly popular. Not only images become highly clear and vivid, but also more powerful functions are supported. The functions are, for example, online video and audio on demand, cloud synchronization, and online downloading, so that a user can select a favorite program.

Smart flat panel televisions are already popular. Because of rapid development of technologies, television sets have become thinner. However, as compared with these foregoing advantages, audio quality stays an exception. Sound performance is always a shortcoming of a television set. Especially, there is a technical limit in achieving an impressive audio effect for a flat panel television having a thin body, and television manufacturers are in need of an effective measure. Although high-definition and ultra-thin visual experience is provided to people, in the aspect of audio quality, many consumers who use smart flat panel televisions complain about low volume of sound, and audio quality of smart flat panel televisions is lower than that of conventional cathode ray tube (CRT) televisions, resulting in that consumers are not satisfied in terms of audio experience.

The reason why smart flat panel televisions have low volume of sound and low audio quality is very simple: loudspeakers of flat panel televisions are too small. Conventionally, a multi-channel surround stereo system, for example, a home cinema, is usually built for a flat panel television, to create a more desirable listening environment. However, in this way, this approach needs to consider factors such as a room size and drilling and wiring, which is not only messy and occupies an area, but also has a relatively high price; therefore, this approach is not a desirable choice for a consumer.

Therefore, soundbars specially used for compensating for insufficient audio quality of flat panel televisions become widely used. A soundbar refers to a strip-shaped speaker that integrates a multi-channel speaker and a power amplifier in one case, and at least has the following advantages:

Each channel in a soundbar has an independent cavity, and ensures desirable isolation and separation.

A soundbar is relatively small and is very convenient to place and move. A soundbar may be placed in front of a television, or may be hung on a wall. Soundbars have various different shapes, sizes, and types, and a soundbar may be customized according to a size of a flat panel television, so as to achieve an integral visual effect with the flat panel television.

A soundbar can support multiple functions. The provided functions may usually include: simulated surround sound, real surround sound, HDMI input, digital and simulated audio input, a universal serial bus (USB) port, Bluetooth support, a subwoofer, and the like.

A soundbar has very simple connection and manipulation, and wiring is also very simple. As compared with a home cinema that has messy wires around a stereo, which severely affects a visual effect, a soundbar speaker usually requires only one connecting cable to accomplish connection with a flat panel television.

As compared with a home cinema, a soundbar has a relatively low price, which is more acceptable to consumers.

However, at present, for connection between a display screen of a flat panel television set of a different brand or a different model and a soundbar, a connecting cable for converting a custom interface into a custom interface specially designed for the brand or the model is generally used.

For example, FIG. 1 shows a connecting cable between a television display screen and a soundbar in the related art. For both ends of the connecting cable, a custom interface is used to implement transmission of a video from a soundbar to a display screen of a television.

In specific disclosure of a user, under limitations of expenditure and space, a soundbar and a display screen of a television may be often not used in combination. Because the foregoing custom interface does not have universality, if a consumer selects another flat panel television, connection with the soundbar having the custom interface cannot be established.

### SUMMARY

The present disclosure provides a method and an apparatus for converting a custom interface into an HDMI interface, so as to resolve a defect in the related art that a soundbar having only a custom interface does not have universality, and implement video output of a soundbar having a custom interface and a television having an HDMI interface by converting a custom interface into an HDMI interface, thereby improving universality of a soundbar having a custom interface.

An embodiment of the present disclosure provides an apparatus for converting a custom interface into an HDMI interface, including: a custom interface, an HDMI interface, and a connecting cable connecting the custom interface and the HDMI interface, where
the custom interface is configured to adaptively connect to a custom interface of a soundbar;
the HDMI interface is configured to adaptively connect to an HDMI interface of a television; and
the connecting cable is configured to separate an HDMI signal from a soundbar signal received by using the custom interface, and transmit the separated HDMI signal to the television by using the HDMI interface.

An embodiment of the present disclosure provides a method for converting a custom interface into an HDMI interface, including:
adaptively connecting, by a custom interface, to a custom interface of a soundbar;
adaptively connecting, by an HDMI interface, to an HDMI interface of a television; and
separating an HDMI signal from a soundbar signal received by using the custom interface, and transmitting the separated HDMI signal to the television by using the HDMI interface.

### BRIEF DESCRIPTION OF THE DRAWINGS

One or more embodiments are exemplarily described by using a diagram that corresponds to the one or more embodiments in the accompanying drawings. These exemplary descriptions do not constitute any limitation on the embodiments. Elements that have the same reference numerals in the accompanying drawings are represented as similar elements. Unless specifically indicated, the diagrams in the accompanying drawings do not constitute any limitations on proportions.

FIG. 1 is a schematic diagram illustrating a soundbar data cable for converting a custom interface into a custom interface in the related art;

FIG. 2 is a schematic structural diagram illustrating an apparatus for converting a custom interface into an HDMI interface according to some embodiments of the present disclosure;

FIG. 3 is a schematic diagram illustrating separation of an HDMI signal from a custom audio/video signal according to some embodiments of the present disclosure;

FIG. 4 is a schematic diagram illustrating HDMI protocol transmission cable control requirements according to some embodiments of the present disclosure; and

FIG. 5 is a schematic flowchart illustrating a method for converting a custom interface into an HDMI interface according to some embodiments of the present disclosure.

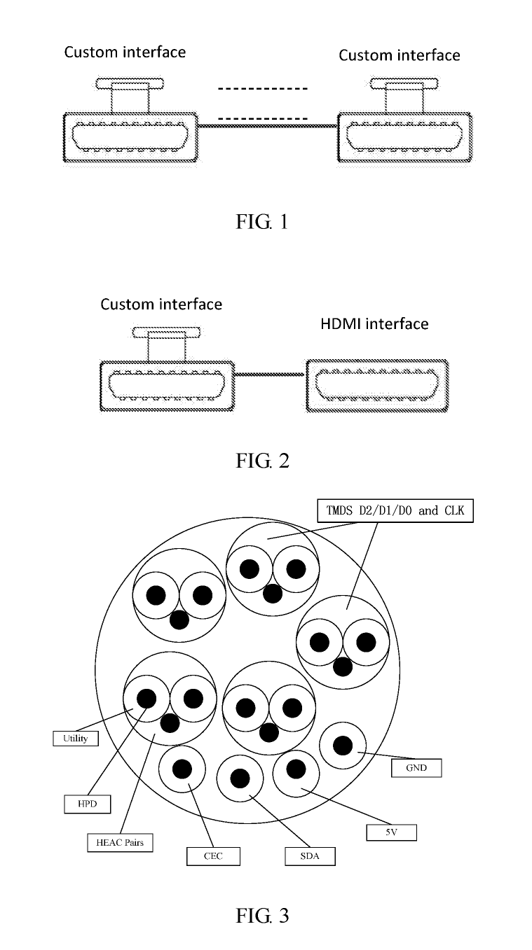

### DETAILED DESCRIPTION

To make the objectives, technical solutions, and advantages of the present disclosure more clearly, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by persons of ordinary skill in the art based on the embodiments of the present disclosure without creative efforts shall fall within the protection scope of the present disclosure.

### Embodiment 1

FIG. 2 is a schematic structural diagram illustrating an apparatus for converting a custom interface into an HDMI interface according to an embodiment of the present disclosure.

In the specific embodiment of the present disclosure, the apparatus for converting a custom interface into an HDMI interface may be a data cable between a soundbar and a television, and is used to connect a soundbar having a custom interface and a television having an HDMI interface, so as to implement video output between the soundbar having the custom interface and the television having the HDMI interface.

As illustrated in FIG. 2, the apparatus for converting a custom interface into an HDMI interface in this embodiment of the present disclosure includes: a custom interface, an HDMI interface, and a connecting cable connecting the custom interface and the HDMI interface, where
the custom interface is configured to adaptively connect to a custom interface of a soundbar;
the HDMI interface is configured to adaptively connect to an HDMI interface of a television; and
the connecting cable is configured to separate an HDMI signal from the custom interface, to make a signal of the custom interface suitable for signal transmission of the HDMI interface.

Specifically, the custom interface can support transmission of three groups of transition minimized differential signaling (TMDS) and transmission of a group of independent TMDS clock signals.

TMDS refers to conversion of original signal data into 10-bit data by using a logic algorithm such as exclusive or and exclusive nor, where the first 8 bits of data are obtained by performing operation on the original signal, the 9^{th} bit indicates a manner of operation, the 10^{th} bit is used to correspond to direct-current balanced, and the converted data is transferred in a differential drive manner.

Three groups of TMDS are used to convert an RGB video signal into a serial signal of data, and a receiving apparatus end then decodes the serial signal into parallel data, and finally converts the parallel data into an 8-bit video signal to perform data transmission. The TMDS clock signal is used to ensure unified timing during transmission.

The HDMI interface is a custom-type digital interface.

The HDMI interface is suitable for video transmission, and can be used to transfer both an audio signal and a video signal. Digital-to-analog or analog-to-digital conversion does not need to be performed before signal transfer, thereby ensuring transfer of video and audio signals having the best quality. Therefore, HDMI is widely applicable to an apparatus such as a set top box, a personal computer, a television gaming console, a digital stereo, and a television set.

The connecting cable includes a TMDS0 channel, a TMDS1 channel, a TMDS2 channel, and a TMDS clock channel. The TMDS0 channel, the TMDS1 channel, the TMDS2 channel, and the TMDS clock channel separate HDMI signals from three groups of TMDS signals and TMDS clock signals received by using the custom interface, and transfer the separated HDMI signals to the HDMI interface.

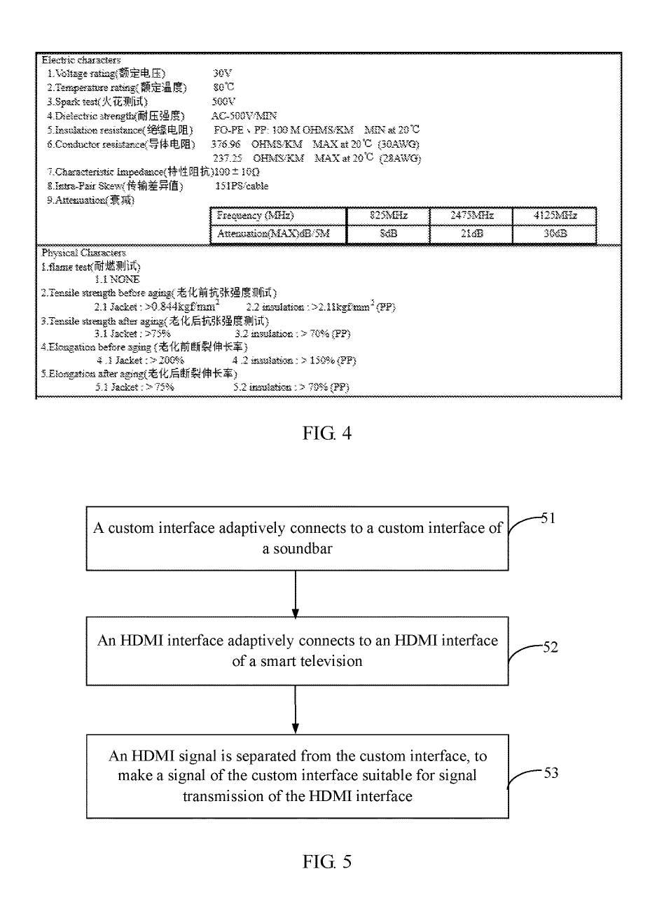

Separation of an HDMI signal from the custom audio/video signal is illustrated in FIG. 3. Specifically, the TMDS0 channel (D0), the TMDS1 channel (D1), the TMDS2 channel (D2), and the TMDS clock channel (CLK) are separately shielded. An HDMI signal is separated from the three groups of TMDS signals and TMDS clock signals received by using the custom interface. HDMI protocol transmission cable control requirements illustrated in FIG. 4 are satisfied, so that the separated HDMI signal can be transferred to the HDMI interface.

### Embodiment 2

FIG. 5 is a schematic flowchart illustrating a method for converting a custom interface into an HDMI interface according to an embodiment of the present disclosure.

As illustrated in FIG. 5, the method of the present disclosure includes:

Step 51: A custom interface adaptively connects to a custom interface of a soundbar.

In this step, the custom interface can support transmission of three groups of TMDS and transmission of a group of independent TMDS clock signals. The three groups of TMDS are used to convert an RGB video signal into a serial signal of data, and a receiving apparatus end then decodes the serial signal into parallel data, and finally converts an 8-bit video signal to perform data transmission. The TMDS clock signal is used to ensure unified timing during transmission.

Step 52: An HDMI interface adaptively connects to an HDMI interface of a television.

In this step, the HDMI interface is suitable for video transmission, and can be used to transfer both an audio signal and a video signal. Digital-to-analog or analog-to-digital conversion does not need to be performed before signal transfer, thereby ensuring transfer of video and audio signals having the best quality. Therefore, HDMI is widely applicable to an apparatus such as a set top box, a personal computer, a television gaming console, a digital stereo, and a television set.

Step 53: An HDMI signal is separated from the custom interface, to make a signal of the custom interface suitable for signal transmission of the HDMI interface.

In this step, a TMDS0 channel, a TMDS1 channel, a TMDS2 channel, and a TMDS clock channel separate HDMI signals from three groups of TMDS signals and a TMDS clock signal received by using the custom interface, and transfer the separated HDMI signals to the HDMI interface.

This embodiment of the present disclosure provides a soundbar data cable for converting a custom interface into an HDMI interface, so as to resolve a defect in the related art that a soundbar having only a custom interface does not have universality, and implement video output of a soundbar having a custom interface and a flat panel television having an HDMI interface by converting a custom interface into an HDMI interface, thereby improving universality of a soundbar having a custom interface.

The described apparatus embodiment is merely exemplary. The modules described as separate parts may or may not be physically separated, and parts shown as modules may or may not be physical modules, which may be located in one position, or may be distributed on multiple network modules. A part of or all of the modules may be selected according to actual needs to achieve the objectives of the solutions of the embodiments. Persons of ordinary skill in the art may understand and implement the embodiments without creative efforts.

What is claimed is:

1. An apparatus for converting a custom interface into an HDMI interface, comprising: the custom interface, the HDMI interface, and a connecting cable connecting the custom interface and the HDMI interface, wherein:
the custom interface is configured to adaptively connect to a custom interface of a soundbar;
the HDMI interface is configured to adaptively connect to an HDMI interface of a television; and
the connecting cable is configured to separate an HDMI signal from a soundbar signal received by using the custom interface, and transmit the separated HDMI signal to the television by using the HDMI interface.

2. The apparatus for converting a custom interface into an HDMI interface according to claim 1, wherein the custom interface can support reception and transmission of three groups of TMDS signals and a group of TMDS clock signals.

3. The apparatus for converting a custom interface into an HDMI interface according to claim 1, wherein the HDMI interface is a custom-type digital interface.

4. The apparatus for converting a custom interface into an HDMI interface according to claim 1, wherein the connecting cable comprises: a TMDS0 channel, a TMDS1 channel, a TMDS2 channel, and a TMDS clock channel; and
the TMDS0 channel, the TMDS1 channel, the TMDS2 channel, and the TMDS clock channel separately shield three groups of TMDS signals and one group of TMDS clock signals received in the custom interface, separate HDMI signals from the three groups of TMDS signals and the group of TMDS clock signals, and transfer the separated HDMI signals to the HDMI interface.

5. The apparatus for converting a custom interface into an HDMI interface according to claim 4, wherein the separated HDMI signals satisfy protocol transmission cable control requirements.

6. A method for converting a custom interface into an HDMI interface, applied to a television, and comprising:
adaptively connecting, by a custom interface, to a custom interface of a soundbar;
adaptively connecting, by an HDMI interface, to an HDMI interface of a television; and
separating an HDMI signal from a soundbar signal received by using the custom interface, and transmitting the separated HDMI signal to the television by using the HDMI interface.

7. The method for converting a custom interface into an HDMI interface according to claim 6, wherein the custom interface can support reception and transmission of three groups of TMDS signals and a group of TMDS clock signals.

8. The method for converting a custom interface into an HDMI interface according to claim 6, wherein the HDMI interface is a custom-type digital interface.

9. The method for converting a custom interface into an HDMI interface according to claim 6, wherein the connecting cable comprises: a TMDS0 channel, a TMDS1 channel, a TMDS2 channel, and a TMDS clock channel; and
the TMDS0 channel, the TMDS1 channel, the TMDS2 channel, and the TMDS clock channel separately shield three groups of TMDS signals and one group of TMDS clock signals received in the custom interface, separate HDMI signals from the three groups of TMDS signals and the group of TMDS clock signals, and transfer the separated HDMI signals to the HDMI interface.

10. The method for converting a custom interface into an HDMI interface according to claim 9, wherein the separated HDMI signals satisfy protocol transmission cable control requirements.
